(19) United States
(12) Patent Application Publication
(10) Pub. No.: US 2009/0061334 A1
(43) Pub. Date: Mar. 5, 2009

(54) TONER, METHOD OF PREPARING TONER, METHOD OF FORMING IMAGE USING THE TONER, AND IMAGE FORMING APPARATUS EMPLOYING THE TONER

(75) Inventors: Yo-da Shin, Incheon Metropolitian City (KR); Kyung-yol Yon, Seongnam-si (KR); Min-young Cheong, Seoul (KR); Tae-hoe Koo, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd.

(21) Appl. No.: 12/193,254

(22) Filed: Aug. 18, 2008

(30) Foreign Application Priority Data
Aug. 29, 2007 (KR) 2007-87040

(51) Int. Cl. G03G 13/04; G03G 5/00; G03G 15/08; G03G 9/093

(52) U.S. Cl. 430/48; 430/137.11; 399/258; 430/110.2

(57) ABSTRACT

A toner and a method of preparing the toner, the method including: preparing first latex particles by polymerizing a toner composition including a macromonomer having a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner, a method of forming an image using the toner, and an image forming apparatus employing the toner.

### CROSS-REFERENCE TO RELATED APPLICATIONS

This application claims priority under 35 U.S.C. §119(a) from Korean Patent Application No. 10-2007-0087040, filed on Aug. 29, 2007, in the Korean Intellectual Property Office, the disclosure of which is incorporated herein in its entirety by reference.

### BACKGROUND OF THE INVENTION

1. Field of the Invention

The present general inventive concept relates to a toner and a method of preparing the toner, and more particularly, to a relatively simple method of preparing toner, whereby, fixing property at a low temperature and durability of toner are improved and a shape and surface state of toner is regulated, toner prepared using the method, a method of forming an image using the toner, and an image forming apparatus employing the toner.

2. Description of the Related Art

In electrophotographic processes or electrostatic recording processes, a developer used to shape an electrostatic image or an electrostatic latent image can be classified as a two-component developer formed of toner and carrier particles, or a one-component developer formed of toner only. The one-component developer can be classified as a magnetic one-component developer or a nonmagnetic one-component developer. Fluiding agents, such as colloidal silica, are often independently added to the nonmagnetic one-component developer to increase a fluidity of the toner. Typically, coloring particles obtained by dispersing a pigment, such as carbon black, or other additives in a binding resin are used as the toner.

Methods of preparing toner include pulverization and polymerization. In pulverization, toner is obtained by melting and mixing synthetic resins with pigments and, if required, other additives, pulverizing the mixture and sorting the particles until particles of a desired size are obtained. In polymerization, a polymerizable monomer composition is manufactured by uniformly dissolving or dispersing various additives, such as a pigment, a polymerization initiator and, if required, a cross-linking agent and an antistatic agent, in a polymerizable monomer. Then, the polymerizable monomer composition is dispersed in an aqueous dispersive medium which includes a dispersion stabilizer using an agitator to shape minute liquid droplet particles. Subsequently, a temperature is increased and suspension polymerization is performed to obtain polymerized toner having coloring polymer particles of a desired size.

In an image forming apparatus, such as an electrophotographic apparatus or an electrostatic recording apparatus, an image is formed by exposing an image on a uniformly charged photoreceptor to form an electrostatic latent image, attaching toner to the electrostatic latent image to form a toner image, transferring the toner image onto a transfer member, such as transfer paper or the like, and then fixing the toner image onto the transfer member using any of a variety of methods, including heating, pressurizing, solvent steaming, and the like. In most fixing processes, the transfer medium with the toner image passes through fixing rollers and pressing rollers, and by heating and pressing, the toner image is fused to the transfer medium.

Images formed by an image forming apparatus, such as an electrophotocopier, should satisfy requirements of high precision and accuracy. Conventionally, toner used in an image forming apparatus is usually obtained by pulverization. In pulverization, color particles having a large range of sizes are formed. Hence, to obtain satisfactory developing properties, there is a need to sort the color particles obtained through pulverization according to size to reduce a particle size distribution. However, it is difficult to precisely control the particle size and the particle size distribution using a conventional mixing/pulverizing process in the manufacture of toner suitable for an electrophotographic process or an electrostatic recording process. Also, when preparing a fine-particle toner, the toner preparation yield is adversely affected by the sorting process. In addition, there are limits to change/adjustment of a toner design for obtaining desirable charging and fixing properties. Accordingly, polymerized toner, the size of particles of which is easy to control and which do not need to undergo a complex manufacturing process, such as sorting, have been highlighted recently.

When toner is prepared through polymerization, polymerized toner having a desired particle size and particle size distribution can be obtained without pulverizing or sorting. However, although such polymerization is used, a surfactant is required to disperse a pigment. The use of the surfactant requires a washing process, and thus manufacturing costs are increased and an amount of wastewater generated is also increased.

For example, U.S. Pat. No. 6,258,911 invented by Georges et al. describes a bifunctional polymer having narrow polydispersity and a method of emulsification-aggregation polymerization for preparing a polymer having free radicals that are covalently-bonded at both ends of the polymer. In such an emulsification-aggregation polymerization, toner particles are prepared by separately preparing a wax dispersion and a pigment dispersion using an ionic surfactant (typically an anionic surfactant), dispersing the prepared polymer latex particles with the wax dispersion and the pigment dispersion using a surfactant, and then agglomerating the resultant dispersion. Alternatively, a polymer latex (or seed) is polymerized in a first operation, and the seed is polymerized with a wax-monomer emulsified dispersion using a seed-treated emulsion polymerization in a second operation, and then toner particles are prepared by agglomerating the dispersed pigment using a surfactant. A method of preparing toner using the conventional emulsification-aggregation is complicated and the surfactant cannot be easily removed, resulting in various problems due to residual surfactant. In particular, the conventional methods require additional operations, such as a washing process, and thus increase pollution to the environment and increase manufacturing costs.

Therefore, there is still a need to develop toner that can be used in high-speed printers, and which is capable of minimizing an amount of wastewater by decreasing an amount of surfactants and improving fixing property at a low temperature and durability.

### SUMMARY OF THE INVENTION

The present general inventive concept provides a relatively simple method of preparing toner, whereby fixing property at a low temperature and durability can be improved, the shape and surface state of toner can be regulated, and the toner can have uniform particle distribution.

The present general inventive concept also provides toner prepared using the method.

The present general inventive concept also provides toner having improved properties, such as controlled particle size, storage, and durability.

The present general inventive concept also provides a method of forming a high-quality image fixed at a low temperature using toner having improved properties, such as controlled particle size, storage, and durability.

The present general inventive concept also provides a high-quality image forming apparatus that can form an image at a low temperature using toner having improved properties, such as controlled particle size, storage, and durability.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of preparing toner, the method including preparing first latex particles by polymerizing a toner composition including a macromonomer having a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner.

The foregoing and/or other aspects and utilities of the present general inventive concept may also be achieved by providing toner prepared using a method including preparing first latex particles by polymerizing a toner composition including a macromonomer having a hydrophilic group, a hydrophobic group and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner.

The foregoing and/or other aspects and utilities of the present general inventive concept may also be achieved by providing a method of forming an image using toner, the method including attaching the toner to a surface of a photoreceptor on which an electrostatic latent image is formed to form a visualized image and transferring the visualized image to a transfer medium, wherein the toner is prepared using a method including preparing first latex particles by polymerizing a toner composition including a macromonomer having a hydrophilic group, a hydrophobic group and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which is prepared by polymerizing a composition for the second latex particles including at least one polymerizable monomer and a cross-linkable monomer on the first agglomerated toner.

The foregoing and/or other aspects and utilities of the present general inventive concept may also be achieved by providing an image forming apparatus including an electrophotographic photoreceptor, an image forming unit that forms an electrostatic latent image on a surface of the electrophotographic photoreceptor, a unit to receive toner, a toner supplying unit that supplies the toner onto the surface of the electrophotographic photoreceptor in order to form a toner image by developing the electrostatic latent image on the surface of the electrophotographic photoreceptor, and a toner transferring unit that transfers the toner image to a transfer medium from the surface of the electrophotographic photoreceptor, wherein the toner is prepared using a method including preparing first latex particles by polymerizing a toner composition including a macromonomer having a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which is prepared by polymerizing a composition for the second latex particles including at least one polymerizable monomer and a cross-linkable monomer on the first agglomerated toner.

The foregoing and/or other aspects and utilities of the present general inventive concept may also be achieved by providing a method of preparing a toner composition, the method including preparing first latex particles by polymerizing an amphiphillic macromonomer and at least one polymerizable monomer, dispersing a pigment in a solution comprising the amphiphillic macromonomer as a dispersant, mixing the first later particles with the pigment solution to agglomerate the latex particles and the pigment into a toner core, preparing second latex particles by polymerizing the amphiphillic macromonomer and at least one polymerizable monomer, and coating the second latex particles to encapsulate the toner core.

The preparation of the first latex particles may further include adding a wax during the preparation of the first latex particles, and the toner core includes the wax.

The second latex particles may have a higher glass transition temperature than the first later particles.

At least one of the preparation of the first latex particles, the preparation of the toner core, and the coating of the second latex particles on the toner core may be performed without a surfactant.

The first latex particles may have a double layer structure.

The preparation of the first latex particles may further include adding an additional polymerizable monomer to prepare first latex particles having a double layer structure.

The foregoing and/or other aspects and utilities of the present general inventive concept may also be achieved by providing a toner composition, including a toner core comprising first latex particles and a colorant, and a shell layer comprising second latex particles to encapsulate the toner core.

The first latex particles may have a double layer structure and further comprise a wax.

The second latex particles may have a higher glass transition temperature than the first latex particles.

The first and second particles may be prepared by polymerizing an amphiphillic macromonomer and at least one polymerizable monomer.

The colorant may be a pigment, and the toner core may be formed by mixing the first latex particles with the pigment dispersed in a solution using an amphiphillic macromonomer as a dispersant.

According to embodiments of the present general inventive concept, toner to form high-quality images that can be used in high-speed printers can be provided, a process of manufacturing toner can be simplified, an amount of wastewater can be minimized by decreasing an amount of surfactants, fixing property at a low temperature and durability can be improved by additionally agglomerating second latex particles having a relatively higher Tg than first latex particles as a shell layer on a core in which the first latex particles including a wax is formed, z shape and surface state of toner can be regulated, and particle distribution can be uniform.

### BRIEF DESCRIPTION OF THE DRAWINGS

The above and other aspects and utilities of the present general inventive concept will become apparent and more readily appreciated from the following description of the embodiments, taken in conjunction with the accompanying drawings of which:

FIG. 1 is a schematic diagram illustrating an image forming apparatus employing toner prepared according to an embodiment of the present general inventive concept;

FIGS. 2A and 2B are scanning electron microscope (SEM) images of toner prepared according to Example 1;

FIGS. 3A and 3B are SEM images of toner prepared according to Example 2;

FIGS. 4A and 4B are SEM images of toner prepared according to Comparative Example 1; and

FIGS. 5A and 5B are SEM images of toner prepared according to Comparative Example 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept provides a relatively simple method of preparing toner, which minimizes an amount of wastewater by decreasing an amount of a surfactant used. In particular, the amount of the surfactant can be dramatically reduced while a dispersing ability of a pigment is maintained by dispersing the pigment using a dispersible macromonomer with a hydrophilic group and a hydrophobic group. Accordingly, various problems caused by excessive use of surfactant can be solved. In addition, toner to form high-quality images and that can be used in high-speed printers can be provided. A fixing property at a low temperature and durability of the toner can be improved by additionally agglomerating second latex particles having a relatively higher glass transition temperature (Tg) than first latex particles as a shell layer on a core in which the first latex particles including a wax is formed, a shape and surface state of toner can be regulated, and a particle distribution can be uniform.

The present general inventive concept provides a method of preparing toner, the method including: preparing first latex particles by polymerizing a toner composition including a macromonomer having a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner.

The molecular weight (Mw), glass transition temperature (Tg), and rheological properties of the first particles constituting the core of toner particles prepared using the method may be controlled to be fixed at a low temperature.

The rheological properties are determined by a complex modulus, i.e., a storage modulus (G′) and a loss modulus (G′) determined by dynamic tests, and controlled by complex viscosity. In addition, a relaxation modulus of elasticity and relaxation time can be measured. Such stress-relaxation behavior is affected by molecular weight and structure of the toner binder resin, and an amount of wax contained in the toner. When the complex viscosity is too low (less than 1.0×10² Pas), offset or peeling failure may occur in a fixing device. On the other hand, when the complex viscosity is too high (greater than 1.0×10⁴ Pas), adhesion may not be sufficient when fixed and glossiness may decrease, and thus the toner may not be efficiently applied to paper.

Meanwhile, when the molecular weight (Mw) of the binder resin constituting toner is controlled to be less than 30,000, the Tg of the binder resin is controlled to be about 50° C., and rheological properties of the binder resin are decreased, a fixing ratio can be increased, but problems, such as offset, may occur. To overcome such problems, a conventional method of cross-linking resins includes controlling reactivity of the macromonomer participating in the polymerization. However, problems, such as decrease in durability, are not completely overcome using this method. Accordingly, in the present general inventive concept, toner is encapsulated by coating the second latex particles as a shell layer on the first agglomerated toner to improve durability and to overcome storage problems during shipping and handling.

Here, an inhibitor may further be added to the reactor to prevent new latex particles from being formed, or the reaction may be performed using starved-feed processes to facilitate coating of the monomer mixture on the toner.

The polymerizable monomer may be at least one of a vinyl monomer, a polar monomer having a carboxyl group, a monomer having an unsaturated polyester group, and a monomer having a fatty acid group.

The polymerizable monomer may be at least one of styrene-based monomers, such as styrene, vinyl toluene, and a-methyl styrene; acrylic acid or methacrylic acid; derivatives of (metha)acrylates, such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and metacryl amide; ethylenically unsaturated monoolefins, such as ethylene, propylene, and butylenes; halogenized vinyls, such as vinyl chloride, vinylidene chloride, and vinyl fluoride; vinyl esters, such as vinyl acetate, and vinyl propionate; vinyl ethers, such as vinyl methyl ether, and vinyl ethyl ether; vinyl ketones, such as vinyl methyl ketone, and methyl isoprophenyl ketone; and nitrogen-containing vinyl compounds, such as 2-vinylpyridine, 4-vinylpyridine and N-vinyl pyrrolidone, but the present general inventive concept is not limited thereto.

Since the macromonomer used as a comonomer during the polymerization of the latex according to the present general inventive concept maintains stability of the latex in an aqueous solution, a surfactant does not need to be used in the preparation and agglomeration of the polymer latex.

That is, at least one of the preparation of the first latex particles, the preparation of the first agglomerated toner, and the coating of the second latex particles on the first agglomerated toner may be performed without a surfactant.

The macromonomer used herein is an amphiphilic material which has a hydrophilic group and a hydrophobic group in a polymer or oligomer form having at least one reactive functional group at its ends.

The hydrophilic group of the macromonomer which is chemically combined on the surface of toner particles improves long term stability of the toner particles by steric stabilization, and the size of latex particles can be adjusted according to the amount or molecular weight of the added macromonomer. The hydrophobic group of the macromonomer which is on the surface of the toner particles can facilitate emulsion polymerization reaction. The macromonomer may form a copolymer with the polymerizable monomer included in the toner composition by grafting, branching, cross-linking, or the like.

A weight average molecular weight of the macromonomer may be in the range of 100 to 100,000, and may also be 1,000 to 10,000. When the weight average molecular weight of the macromonomer is less than 100, physical properties of the toner are not improved or the toner cannot efficiently function as a stabilizer. On the other hand, when the weight average molecular weight of the macromonomer is greater than 100,000, the reaction conversion rate may be lowered.

The macromonomer may be a material selected from polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate, but the present general inventive concept is not limited thereto.

The macromonomer can function not only as a comonomer but also as a stabilizer. Initial reaction of radicals and monomers creates oligomer radicals and shows an in-situ stabilization effect. An initiator decomposed by heat creates radicals and reacts with a monomer in an aqueous solution to form an oligomer radical, and the hydrophobicity of the solution increases. Such hydrophobicity of oligomer radicals facilitates diffusion into micelle and facilitates reaction with polymerizable monomers, and together with this, a copolymerization reaction with macromonomers can be performed.

Due to the hydrophilicity of the macromonomer, copolymerization can easily occur in a vicinity of the surface of the toner particles. The hydrophilic portions of the macromonomer located on a surface of the toner particles increase stability of the toner particles by steric stabilization, and a size of the toner particles can be adjusted according to an amount or molecular weight of the macromonomers. Also, functional groups reacting on the surface of the toner particles can improve frictional electrical properties of the toner.

The amount of the macromonomer may be in the range of 0.1 to 10 parts by weight, 2 to 6 parts by weight, and may also be 2 to 4 parts by weight based on 100 parts by weight of the polymerizable monomer. When the amount of the macromonomer is less than 0.1 parts by weight based on 100 parts by weight of the polymerizable monomer, dispersion stability of the toner particles may decrease and yield may decrease. On the other hand, when the amount of the macromonomer is greater than 10 parts by weight based on 100 parts by weight of the polymerizable monomer, physical properties of the toner may deteriorate.

The wax enables toner to be fixed on a final image receptor at a low temperature and to show excellent final image durability and resistance to abrasion. Examples of the wax include polyethylene-based wax, polypropylene-based wax, silicon wax, paraffin-based wax, ester-based was, carbauna wax, and metallocene wax, but are not limited thereto. The melting point of the wax may be in the range of about 50 to about 150° C. Wax constituents are physically attached to the toner particles, but may not be covalently bonded with toner particles.

An amount of the wax may be in the range of 2 to 15 parts by weight, 2 to 10 parts by weight, and may also be 4 to 10 parts by weight based on 100 parts by weight of the polymerizable monomer. When the amount of the wax is less than 2 parts by weight based on 100 parts by weight of the polymerizable monomer, a fixing ratio may decrease. On the other hand, when the amount of the wax is greater than 15 parts by weight based on 100 parts by weight of the polymerizable monomer, storage properties of the toner may deteriorate.

The first latex particles may have a double-layered structure by polymerizing the toner composition and then adding at least one polymerizable monomer thereto and polymerizing the monomer.

When the first latex particles have the double-layered structure as described above, the wax is less likely to be discharged to the surface of the toner.

A medium used herein to prepare toner may be an aqueous solution, an organic solvent, or a mixture thereof.

The second latex particles can be prepared by polymerizing a composition for the second latex particles including at least one polymerizable monomer and a cross-linkable monomer.

Here, the polymerizable monomer may be a vinyl monomer, a polar monomer having a carboxyl group, a monomer having an unsaturated polyester group, or a monomer having a fatty acid group. Examples of the polymerizable monomer are described above.

In addition, the cross-linkable monomer may be a polymerizable monomer having at least three functional groups which can cross-link, i.e., a cross-linking agent. Examples of the cross-linkable monomer include at least one of triallyl isocyanurate, (di)ethylene glycol di(metha)acrylate, trimethylolpropane triacrylate, trimethylolethylene triacrylate, divinyl pyridine, quinone dioxime, benzoquinone dioxime, p-nitrosophenol, and N,N′-m-phenylene-bismaleimide, but are not limited thereto. In particular, the cross-linkable monomer may be a multi-functional group, such as (metha)acrylate (e.g., pentaerytritol triacrylate, or trimethylol propanetri(metha)acrylate).

An amount of the cross-linkable monomer may be in the range of 0.5 to 5 parts by weight, 0.5 to 3 parts by weight, and may also be 1 to 2 parts by weight based on 100 parts by weight of the polymerizable monomer. When the amount of the cross-linkable monomer is less than 0.5 parts by weight based on 100 parts by weight of the polymerizable monomer, cross-linking cannot be sufficiently performed. On the other hand, when the amount of the cross-linkable monomer is greater than 5 parts by weight based on 100 parts by weight of the polymerizable monomer, a polymerization degree of the latex may be decreased.

Processes of preparing a first agglomerated toner constituting a core of the toner and coating second latex particles on the first agglomerated toner according to an embodiment of the present general inventive concept will now be described in detail.

First, first latex particles are prepared by polymerizing a toner composition including a macromonomer, at least one polymerizable monomer, and a wax.

More particularly, while an inside of a reactor is purged with nitrogen gas or the like, a mixture solution of a medium, such as distilled deionized water (or a mixture of water and an organic solvent), and the macromonomer is added to the reactor and heated while stirring. An electrolyte or an inorganic salt, such as NaOH or NaCl, may be added thereto to adjust ionic strength of the reaction medium. When a temperature inside the reactor reaches a certain level, an initiator, such as a water-soluble free radical initiator, may be introduced. Then, at least one polymerizable monomer may be added to the reactor using a semi-continuous method with a chain transfer agent. Here, polymerizable monomer may be slowly provided using a starved feed process to adjust a reaction speed and dispersibility of the solution.

The polymerization may be performed in a range of 4 to 8 hours and a polymerization time may be dependent on the reaction temperature and experimental conditions and may be determined by measuring a reaction speed and a conversion rate.

The first latex particles having a double-layered structure may be prepared by adding at least one additional polymerizable monomer to adjust durability or other properties of the toner. Here, the additional polymerizable monomers may be added using a starved feed process to properly form the double-layered structure. An inhibitor may also be added in order to prevent new latex particles from being generated.

When the first latex particles are prepared, a pigment is dispersed using the macromonomer since the macromonomer can maintain dispersibility with both the hydrophilic group and the hydrophobic group. A milling or a homogenizer may be used without limitation as dispersing means and the first agglomerated toner is prepared by adding an inorganic salt to the prepared pigment dispersion and agglomerating them.

Then, prepared second latex particles are coated on the first agglomerated toner to obtain toner particles having a desired size and structure, and then the resultant is filtered to separate the toner particles and dried. The dried toner particles are subjected to a surface treatment using external additives and a charge of the toner particles is controlled to prepare final dry toner.

Here, the second latex particles are prepared in a similar manner as the preparation of the first latex particles using a composition including at least one polymerizable monomer and a cross-linkable monomer. That is, while an inside of a reactor is purged with nitrogen gas or the like, a mixture solution of a medium, such as distilled deionized water (or a mixture of water and an organic solvent), and the macromonomer is added to the reactor and heated while stirring. An electrolyte or an inorganic salt, such as NaOH or NaCl, may be added thereto to adjust an ionic strength of the reaction medium. When a temperature inside the reactor reaches a certain level, an initiator, such as a water-soluble free radical initiator, may be introduced. Then, at least one polymerizable monomer and a cross-linkable monomer may be added to the reactor using a semi-continuous method, if desired, with a chain transfer agent. Here, the polymerizable monomer may be slowly added to the reactor using a starved feed process to adjust a reaction speed and dispersibility of the solution. The polymerization time may be in a range of 4 to 8 hours and is dependent on a reaction temperature and experimental conditions and determined by measuring a reaction speed and a conversion rate.

Since at least one of the preparation of the first latex particles, the preparation of the first agglomerated toner, and the coating of the second latex particles on the first agglomerated toner is performed without a surfactant, washing processes may be minimized in the separation and filtration of the prepared toner particles. Manufacturing costs for the toner may be reduced by minimizing the number of washing processes, and the manufacturing process is more environmentally friendly by decreasing the amount of wastewater generated. Further, problems, such as high sensitivity in high humidity conditions, low frictional charge, reduced dielectric property, and weak toner flow, may not arise since a surfactant is not used. Also, storage stability of the toner can be improved.

The toner may include a pigment, and carbon black or aniline black may be used as the pigment for a black toner.

The toner according to the present general inventive concept can be used to prepare color toner. For color toner, carbon black or aniline black is used as a black colorant, and at least one of yellow, magenta, and cyan pigments are further included for colored colorants.

A condensation nitrogen compound, an isoindolinone compound, an anthraquine compound, an azo metal complex, or an allyl imide compound can be used as the yellow pigment. In particular, C.I. pigment yellow 12, 13, 14, 17, 62, 74, 83, 93, 94, 95, 109, 110, 111, 128, 129, 147, 168, 180, or the like can be used as the yellow pigment.

A condensation nitrogen compound, an anthraquine compound, a quinacridone compound, a base dye lake compound, a naphthol compound, a benzo imidazole compound, a thioindigo compound, or a perylene compound can be used as the magenta pigment. In particular, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, or the like can be used as the magenta pigment.

A copper phthalocyanine compound and derivatives thereof, an anthraquine compound, or a base dye lake compound can be used as the cyan pigment. In particular, C.I. pigment blue 1, 7, 15, 15:1, 15:2, 15:3, 15:4, 60, 62, 66, or the like can be used as the cyan pigment.

Such pigments can be used alone or in a combination of at least two pigments, and may be selected in consideration of color, chromaticity, luminance, resistance to weather, dispersion property in toner, etc.

An amount of the pigment as described above may be 0.1 to 20 parts by weight based on 100 parts by weight of the polymerizable monomer. The amount of the pigment should be sufficient to color the toner; however, when the amount of the pigment is less than 0.1 parts by weight based on 100 parts by weight of the polymerizable monomer, the coloring effect is not sufficient. On the other hand, when the amount of the pigment is greater than 20 parts by weight based on 100 parts by weight of the polymerizable monomer, the manufacturing costs of the toner increase, and sufficient frictional charge amount may not be obtained.

In addition, the first agglomerated toner can be agglomerated by adding an inorganic salt to a mixed solution of the first latex particles and the pigment dispersion. That is, the size of the first agglomerated toner increases due to increased ionic strength by the addition of the inorganic salt and collisions between the particles.

In particular, when a concentration of the inorganic salt is heavier than a critical coagulation concentration (CCC), an electrostatic repulsive force between latex particles is offset, and thus agglomeration rapidly occurs due to Brownian motion of the polymer latex particles. When a concentration of the inorganic salt is lower than the CCC, agglomeration speed becomes slow, and thus agglomeration can be controlled. The inorganic salt may be at least one of NaCl, MgCl₂.8H₂O, [Al₂(OH)ₙCl₆₋ₙ]ₘ where 1≦n≦5 and 1≦m≦10, and Al₂(SO₄)₃. 18H₂O, but is not limited thereto.

The toner according to the present general inventive concept may further include at least one of an initiator, a chain transfer agent, a release agent, and a charge control agent.

That is, in the preparation process of the toner, radicals may be created by the initiator in the toner composition, and the radicals may react with the polymerizable monomer. The radicals may form a copolymer by reacting with the polymerizable monomer and reactive functional groups of the macromonomer.

Examples of the initiator for radical polymerization are persulfate salts, such as potassium persulfate, and ammonium persulfate; azo compounds, such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile, and 1,1′-azobis(1-cyclohexanecarbonitrile); and peroxides, such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, and di-t-butylperoxy isophthalate. Also, an oxidization-reduction initiator in which the polymerization initiator and a reduction agent are combined may be used.

A chain transfer agent is a material that converts a type of chain carrier in a chain reaction. A new chain has much less activity than that of a previous chain. The polymerization degree of the monomer can be reduced and new chains can be initiated using a chain transfer agent. In addition, a molecular weight distribution can be adjusted using a chain transfer agent.

Examples of the chain transfer agent include sulfur containing compounds, such as dodecanthiol, thioglycolic acid, thioacetic acid, and mercaptoethanol; phosphorous acid compounds, such as phosphorous acid and sodium phosphite; hypophosphorous acid compounds, such as hypophosporous acid and sodium hypophosphite; and alcohols, such as methyl alcohol, ethyl alcohol, isopropyl alcohol, and n-butyl alcohol; but the present general inventive concept is not limited thereto.

The release agent can be used to protect a photoreceptor and prevent deterioration of developing, thereby obtaining a high-quality image. A release agent may be a high purity solid fatty acid ester material. Examples of the release agent include low molecular weight polyolefins, such as low molecular weight polyethylene, low molecular weight polypropylene, and low molecular weight polybutylene; paraffin wax; and multi-functional ester compounds. The release agent used in the present general inventive concept may be a multifunctional ester compound composed of alcohol having three functional groups or more and carboxylic acid.

The alcohol having three functional groups or more may be aliphatic alcohols, such as glycerin, pentaerythritol, and pentaglycerol; alicyclic alcohols, such as chloroglycitol, quersitol, and inositol; aromatic alcohols, such as tris(hydroxymethyl) benzene; sugars, such as D-erythrose, L-arabinose, D-mannose, D-galactose, D-fructose, L-lamunose, sucrose, maltose, and lactose; or sugar-alcohols, such as erythrite.

The carboxylic acid may be aliphatic carboxylic acids, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, and tetrolic acid; alicyclic carboxylic acids, such as cyclohexanecarboxylic acid, hexahydroisophthalic acid, hexahydroterephthalic acid, and 3,4,5,6-tetrahydrophthalic acid; or aromatic carboxylic acids, such as benzoic acid, cumic acid, phthalic acid, isophthalic acid, terephthalic acid, trimeth acid, trimellitic acid, and hemimellitic acid.

The charge control agent may be a salicylic acid compound containing metals, such as zinc and aluminum, boron complexes of bis diphenyl glycolic acid, and silicate. Additionally, dialkyl salicylic acid zinc, boro bis(1,1-diphenyl-1-oxo-acetyl potassium salt), or the like can also be used as the charge control agent.

According to another embodiment of the present general inventive concept, there is provided a toner prepared using a method including: preparing first latex particles by polymerizing a toner composition including a macromonomer having a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner.

In the preparation of the toner, at least one of the preparation of the first latex particles, the preparation of the first agglomerated toner, and the coating of the second latex particles on the first agglomerated toner may be performed without a surfactant. Detailed descriptions thereof are disclosed above.

A volume average diameter of toner particles may be in the range of 3 to 20 μm, and may also be 5 to 8 μm. When the volume average diameter of toner particles is less than 3 μm, the electrophotographic photoreceptor cannot be completely cleaned and yield when mass produced may decrease. On the other hand, when the volume average diameter is greater than 20 μm, a charging process is not uniformly performed, fixing properties of the toner are decreased, and a regulating blade may not adequately regulate the toner layer.

A weight average molecular weight of the macromonomer may be in the range of 100 to 100,000, and may also be 1,000 to 10,000. Examples of the macromonomer are polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate, but are not limited thereto.

According to another embodiment of the present general inventive concept, there is provided a method of forming an image using toner, the method comprising attaching the toner to a surface of a photoreceptor on which an electrostatic latent image is formed to form a visualized image and transferring the visualized image to a transfer medium, whereby the toner is prepared using a method including: preparing first latex particles by polymerizing a toner composition including a macromonomer including a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner.

A representative electrophotographic image forming process includes a series of processes to form images on a receptor, including charging, exposure to light, developing, transferring, fixing, cleaning, and erasing process operations.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to form a latent image. Electromagnetic radiation, that can be referred to as “light,” includes infrared radiation, visible light, and ultraviolet radiation.

In the developing process, appropriately-charged toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and form a toner image on the photoreceptor.

In the transferring process, the toner image is transferred to the final image receptor from the photoreceptor, and an intermediate transferring element may be used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat.

In the cleaning process, residual toner remaining on the photoreceptor is removed.

Finally, in the erasing process, charges of the photoreceptor are exposed to light of a predetermined wavelength band and are reduced to be substantially uniform and of low value, and thus the residue of the organic latent image is removed and the photoreceptor is prepared for a next image forming cycle.

According to another embodiment of the present general inventive concept, there is provided an image forming apparatus including an electrophotographic photoreceptor, an image forming unit that forms an electrostatic latent image on a surface of the electrophotographic photoreceptor, a unit for receiving the toner, a toner supplying unit that supplies the toner onto the surface of the electrophotographic photoreceptor in order to form a toner image by developing the electrostatic latent image on the surface of the electrophotographic photoreceptor, and a toner transferring unit that transfers the toner image to a transfer medium from the surface of the electrophotographic photoreceptor. The toner is prepared using a method including: preparing first latex particles by polymerizing a toner composition including a macromonomer including a hydrophilic group, a hydrophobic group, and at least one reactive functional group; at least one polymerizable monomer; and a wax; preparing a first agglomerated toner by mixing the first latex particles with a pigment dispersion dispersed by the macromonomer and adding an inorganic salt to the mixture; and coating second latex particles which are prepared by polymerizing a composition for the second latex particles including at least one polymerizable monomer and a cross-linkable monomer on the first agglomerated toner.

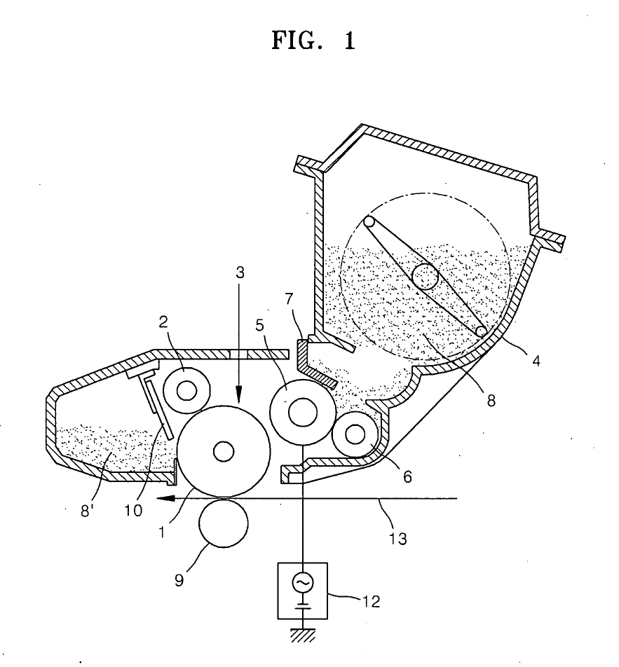

FIG. 1 is a schematic diagram of a non-contact developing type image forming apparatus using a toner prepared using a method according to an embodiment of the present general inventive concept.

Referring to FIG. 1, the non-contact developing type image forming apparatus according to the current embodiment of the present general inventive concept includes a developer 8, which is a nonmagnetic one-component developer of a developing unit 4, and which is supplied to a developing roller 5 through a feeding roller 6 formed of an elastic material, such as a polyurethane foam or sponge. The developer 8 supplied to the developing roller 5 reaches a contact point between the developing roller 5 and a developer regulation blade 7 as the developing roller 5 rotates. The developer regulation blade 7 is formed of an elastic material, such as an elastic metal or rubber. When the developer 8 passes the contact point between the developing roller 5 and the developer regulation blade 7, the developer 8 is smoothed to form a thin layer that is sufficiently charged. The developing roller 5 transfers the thin layer of the developer 8 to a developing domain where the thin layer of the developer 8 is developed on an electrostatic latent image of a photoreceptor 1, which is a latent image carrier. The electrostatic latent image is formed by scanning light 3 onto the photoreceptor 1.

The developing roller 5 and the photoreceptor 1 face each other with a constant distance therebetween. The developing roller 5 may rotate counterclockwise and the photoreceptor 1 may rotate clockwise.

The developer 8 transferred to the developing domain of the photoreceptor 1 forms a toner image by developing an electrostatic latent image on the photoreceptor 1 according to the intensity of the electric charge generated due to a difference between an AC voltage superposed with a DC voltage applied to the developing roller 5 and a latent image potential of the photoreceptor 1 that is charged by a charging unit 2.

The developer 8 developed on the photoreceptor 1 is transferred to a transferring means 9 as the photoreceptor 1 rotates. The developer 8 developed on the photoreceptor 1 is transferred to a sheet of paper 13 by corona discharge or a roller to which a high voltage having inverse polarity of the developer 8 is applied as the paper 13 passes through the developer 8 developed on the photoreceptor 1, and thus an image is formed.

The image transferred to the printing paper 13 passes through a fixing device (not illustrated) that provides high temperature and high pressure, and the image is fused to the printing paper 13 as the developer 8 is fused to the printing paper 13. Meanwhile, the developer 8′ remaining on the developing roller 5 and which is not developed is transferred back to the feeding roller 6 contacting the developing roller 5. Remaining developer 8′ that is undeveloped on the photoreceptor 1 is collected by a cleaning blade 10. The above processes are repeated.

The present general inventive concept will now be described in more detail with reference to the examples below, but is not limited thereto. The following examples are for illustrative purposes only and are not intended to limit the scope of the general inventive concept.

### EXAMPLE 1

### Preparation of First Latex Particles Having a Single-Layered Structure

While an inside of a reactor was purged with nitrogen gas, a mixture solution of 470 g of distilled deionized water and 5 g of poly(ethylene glycol)-ethyl ether methacrylate (PEG-EEM, Aldrich) as a macromonomer was added to the reactor and heated while stirring at 250 rpm. 100 g of a polymerizable monomer mixture of styrene, n-butyl acrylate, and methacrylic acid in a weight ratio of 75:23:2, 3.5 g of 1-dodecanethiol as a chain transfer agent, and 20 g of ester wax were melted at 60° C., and dispersed using ultrasonic waves for 5 minutes, and then added to the reactor using a starved-feed process when a temperature of the inside of the reactor reached 82° C. 2.0 g of potassium persulfate (KPS) dissolved in 20 g of deionized water as a water soluble free radical initiator was added to the reactor. The reaction was performed for 4 to 6 hours, and the resultant was cooled naturally while stirring. A particle size of the first latex particles was 200 nm, a Tg was 46° C., a weight average molecular weight was 45,000, and a conversion rate was about 99.8%.

### Preparation of Second Latex Particles

While an inside of a reactor was purged with nitrogen gas, a mixture solution of 470 g of distilled deionized water and 5 g of poly(ethylene glycol)-ethyl ether methacrylate (PEG-EEM, Aldrich) as a macromonomer was added to the reactor and heated while stirring at 300 rpm. When a temperature in the reactor reached 82° C., 2.0 g of KPS dissolved in 50 g of deionized water as an initiator was added to the reactor. 100 g of a polymerizable monomer mixture of styrene, n-butyl acrylate, methacrylic acid and pentaerytritol triacrylate in a weight ratio of 75:22:2:1 and 3 g of 1-dodecanethiol as a chain transfer agent were added to the reactor using a starved-feed process. The reaction was performed for 4 to 6 hours, and the resultant was cooled naturally while stirring. A particle size of the second latex particles was 200 nm, a Tg was 58° C., a weight average molecular weight (Mw) was 45,000 and a conversion rate was about 99.8%.

### Agglomeration and Preparation of Toner

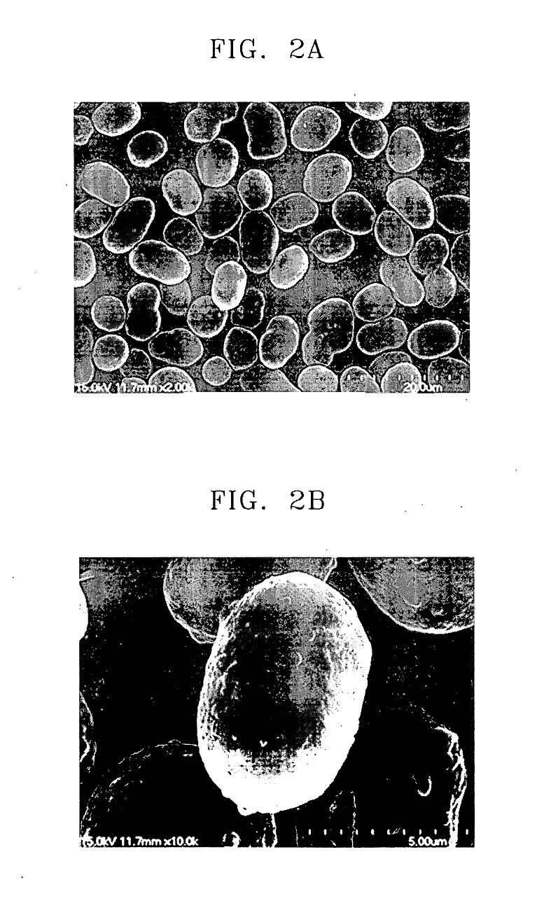

316 g of deionized water and 307 g of the first latex particles prepared according to the process described above were added to a 1 L reactor and stirred at 350 rpm. While stirring, 30 g of a black pigment dispersion including 2 g of HS-10 (DAIICHI-KOGYO) as a macromonomer, 4 g of a black pigment (Legal 330, Cabot K. K.) and 25 g of deionized water was added to the reactor. A pH of the mixture was adjusted to 11, 30 g of MgCl₂ was added to the reactor, and the reactor was gradually heated to 85° C. The mixture was reacted at 85° C. for 2 hours, and reacted with NaCl for an additional 2 hours. Then, 100 g of the second latex particles was added to the reactor, and the mixture was reacted for 6 hours. Then, the mixture was cooled to a temperature of 25° C., which is below the Tg of the final toner, and filtered to separate toner particles and then dried. As a result, the prepared toner particles had a volume average diameter of about 6.5 μm and smooth spherical-shaped surfaces. FIGS. 2A and 2B are scanning electron microscope (SEM) images of toner prepared according to Example 1

### EXAMPLE 2

Toner was prepared in the same manner as in Example 1, except that first latex particles having a double-layered structure were used.

### Preparation of First Latex Particles Having a Double-Layered Structure

While an inside of a reactor was purged with nitrogen gas, a mixture solution of 470 g of distilled deionized water and 5 g of poly(ethylene glycol)-ethyl ether methacrylate (PEG-EEM, Aldrich) as a macromonomer was added to the reactor and heated while stirring at 250 rpm. 100 g of a polymerizable monomer mixture of styrene, n-butyl acrylate, and methacrylic acid in a weight ratio of 75:23:2, 3.5 g of 1-dodecanethiol as a chain transfer agent, and 20 g of ester wax were melted at 60° C., and dispersed using ultrasonic waves for 5 minutes, and then added to the reactor using a starved-feed process when a temperature of the inside of the reactor reached 82° C. 2.0 g of potassium persulfate (KPS) dissolved in 20 g of deionized water as a water soluble free radical initiator was added to the reactor. After 2 hours of reaction, 50 g of the polymerizable monomer mixture of styrene, n-butyl acrylate, and methacrylic acid in a weight ratio of 75:23:2 and 1 g of KPS were dissolved in 40 g of deionized water and the mixture was added to the reactor. The reaction was performed for 4 to 6 hours, and the resultant was cooled naturally while stirring. A particle size of the first latex particles was 200 nm, a Tg was 46° C., a weight average molecular weight was 45,000, and a conversion rate was about 99.6%.

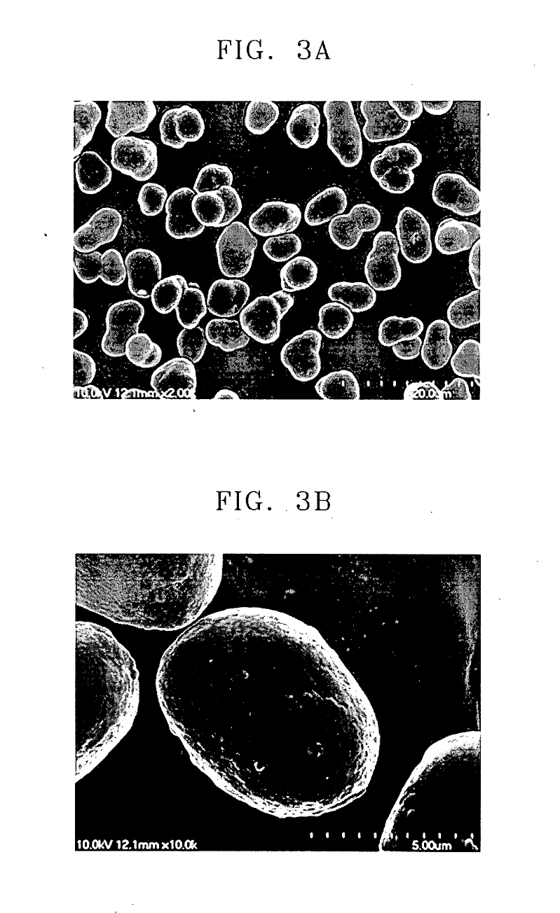

The prepared toner had potato-shaped particles having a smooth surface and a volume average diameter of about 6.5 μm. FIGS. 3A and 3B are SEM images of toner prepared according to Example 2.

### COMPARATIVE EXAMPLE 1

Toner was prepared in the same manner as in Example 1, except that first latex particles having a triple-layered structure of a core layer, a wax layer and a shell layer were used.

Preparation of First Latex particles Having a Triple-Layered Structure

While the inside of a reactor was purged with nitrogen gas, a mixture solution of 470 g of distilled deionized water and 5 g of poly(ethylene glycol)-ethyl ether methacrylate (PEG-EEM, Aldrich) as a macromonomer was added to the reactor and heated while stirring at 250 rpm. 100 g of a polymerizable monomer mixture of styrene, n-butyl acrylate, and methacrylic acid in a weight ratio of 75:23:2 and 3.5 g of 1-dodecanethiol as a chain transfer agent were added to the reactor using a starved-feed process. 15 g of ester wax was dissolved in a mixture of 28.1 g of a polymerizable monomer mixture of styrene, n-butyl acrylate, and methacrylic acid in a weight ratio of 75:23:2 and 3.5 g of 1-dodecanethiol while heating. Then, the mixture was dispersed in a mixture of 190 g of distilled water and 4 g of poly(ethylene glycol)-ethyl ether methacrylate (PEG-EEM, Aldrich) as a macromonomer to prepare a wax dispersion. The wax dispersion was added to the reactor, and 1 g of KPS dissolved in 40 g of deionized water was added to the reactor. The reaction was performed for 4 to 6 hours, and the resultant was cooled naturally while stirring. A particle size of the first latex particles was 400 nm, a Tg was 46° C., a weight average molecular weight was 45,000, and a conversion rate was about 99.8%.

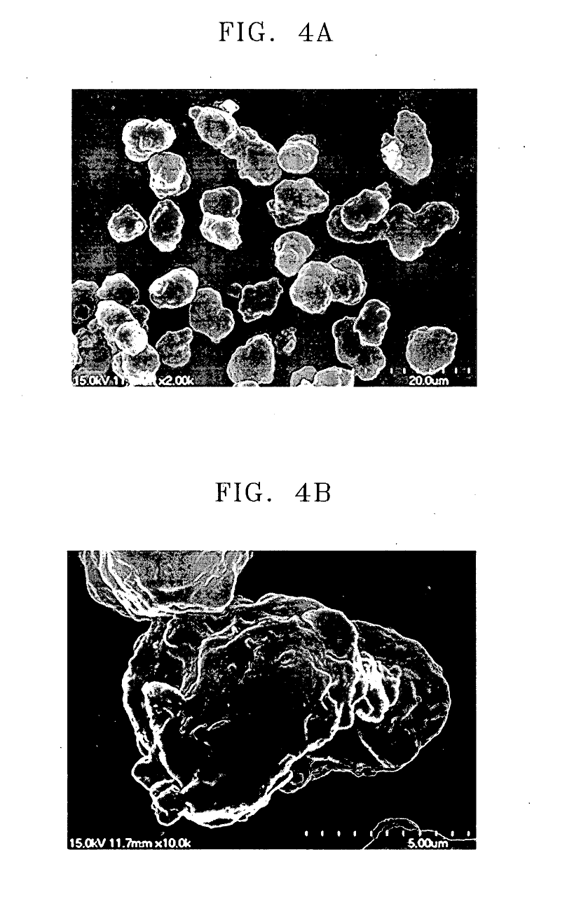

As a result, the prepared toner had irregular-shaped particles having a rough surface and a volume average diameter of about 6.5 μm. FIGS. 4A and 4B are SEM images of toner prepared according to Comparative Example 1

### COMPARATIVE EXAMPLE 2

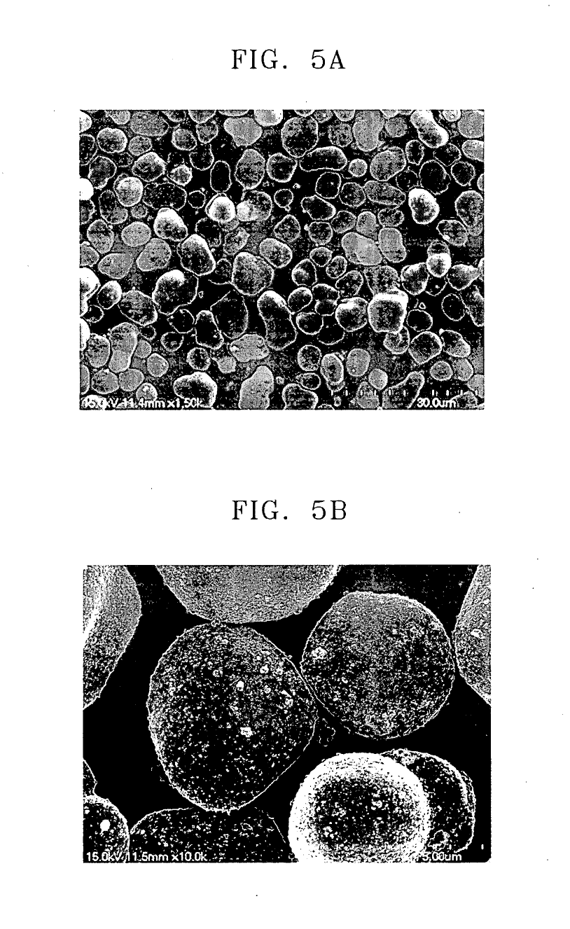

500 g of deionized water, 150 g of first latex particles prepared in Example 1, 28 g of a wax dispersion (9.8 g of ester wax and 18.2 g of deionized water) and 35 g of a pigment dispersion (6.3 g of black pigment (Legal 330, Cabot, K. K.) and 28.7 g of deionized water) were added to a 1 L reactor. Then, a mixture of 15 g of nitric acid (0.3 mol) and 15 g of poly aluminum chloride (PAC) was added to the reactor. The reactor was stirred at 11,000 rpm for 6 minutes using a homogenizer to obtain agglomerated particles having a volume average diameter of 1.5 to 2.5 μm. Then, a mixture including the agglomerated particles was added to a 1 L double jacket reactor and heated from room temperature to 50° C. (5° C. less than the Tg of the first latex particles) at a rate of 1° C. per minute. When the toner particles had a volume average diameter of about 5.5 μm, and 2% of the toner particles had a volume average diameter of 3 μm, 50 g of the second latex particles used in Example 1 was added thereto. When the volume average diameter of the toner particles reached 5.8 μm, NaOH (1 mol) was added to adjust the pH to 7. The volume average diameter of the toner particles was constantly maintained for 10 minutes, while the temperature was raised to 96° C. at a rate of 1° C./min. When the temperature reached 96° C., nitric acid (0.3 mol) was added to adjust the pH to 6.6. The mixture was then reacted to coalesce for 3 to 5 hours. Then, the agglomerated mixture was cooled to 25° C., which is less than the Tg of the final toner, and the toner particles were isolated through filtration and dried. The prepared toner had potato-shaped particles having a volume average diameter of about 6.2 μm. FIGS. 5A and 5B are SEM images of toner prepared according to Comparative Example 2.

As a result of examining toner prepared according to Examples 1 to 2 and Comparative Examples 1 to 2, the result described below was obtained.

When the Tg of the second latex particles forming a shell layer of toner is higher than 55° C. and the molecular weight of the second latex particles is greater than 50,000, a conventional process of agglomeration and fusion needs to be performed at a temperature higher than 95° C. that is conventionally applied to the process in order to smooth the surface of toner as described in Comparative Example 2.

Meanwhile, toner particles prepared according to Comparative Example 1 in which the first latex particles having a triple-layered structure in which the wax layer is the central layer were used had an irregular shape and a rough surface.

However, according to Examples 1 and 2 of the present general inventive concept, toner having a smooth surface can be obtained even though the agglomeration and fusion are performed at 85° C. that is lower than the conventionally applied temperature by using the first latex particles having the single-layered structure including wax or the double-layered structure including the wax layer in the center.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preparing toner, the method comprising:
preparing first latex particles by polymerizing a toner composition comprising:
a macromonomer having a hydrophilic group, a hydrophobic group, and at least one reactive functional group,
at least one polymerizable monomer,
and a wax;
preparing a first agglomerated toner by mixing the first latex particles with a pigment dispersion dispersed by the macromonomer and adding an inorganic salt to the mixture; and
coating second latex particles which are prepared by polymerizing a composition for the second latex particles comprising at least one polymerizable monomer and a cross-linkable monomer on the first agglomerated toner.

2. The method of claim 1, wherein the first latex particles have a double-layered structure by polymerizing the toner composition and then adding at least one polymerizable monomer thereto and polymerizing the monomer.

3. The method of claim 1, wherein the toner composition comprises 0.1 to 10 parts by weight of the macromonomer and 2 to 15 parts by weight of the wax based on 100 parts by weight of the polymerizable monomer.

4. The method of claim 1, wherein the macromonomer is selected from a group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

5. The method of claim 1, wherein the polymerizable monomer is at least one monomer selected from a group consisting of a vinyl monomer, a polar monomer having a carboxyl group, a monomer having an unsaturated polyester group, and a monomer having a fatty acid group.

6. The method of claim 1, wherein the composition for the second latex particles comprises 100 parts by weight of the polymerizable monomer and 0.5 to 5 parts by weight of the cross-linkable monomer.

7. The method of claim 1, wherein the cross-linkable monomer is at least one monomer selected from a group consisting of triallyl isocyanurate, (di)ethylene glycol di(metha)acrylate, trimethylolpropane triacrylate, trimethylolethylene triacrylate, divinyl pyridine, quinone dioxime, benzoquinone dioxime, p-nitrosophenol, and N,N′-m-phenylene-bismaleimide.

8. The method of claim 1, wherein the pigment is selected from a group consisting of yellow, magenta, cyan, and black pigments.

9. The method of claim 1, wherein the inorganic salt is at least one selected from a group consisting of NaCl, MgCl₂.8H₂O, [Al₂(OH)ₙCl₆₋ₙ]ₘ where 1≦n≦5 and 1≦m≦10, and (Al₂(SO₄)₃ .18H₂O).

10. A toner usable in an image forming apparatus prepared by:
preparing first latex particles by polymerizing a toner composition comprising:
a macromonomer having a hydrophilic group, a hydrophobic group and at least one reactive functional group,
at least one polymerizable monomer,
and a wax;
preparing a first agglomerated toner by mixing the first latex particles with a pigment dispersion dispersed by the macromonomer and adding an inorganic salt to the mixture; and
coating second latex particles which are prepared by polymerizing a composition for the second latex particles comprising at least one polymerizable monomer and a cross-linkable monomer on the first agglomerated toner.

11. The toner of claim 10, wherein a volume average diameter of particles of the toner is in a range of about 3 to 20 μm.

12. The toner of claim 10, wherein the macromonomer is selected from a group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

13. A method of forming an image using toner according to claim 10, the method comprising:
attaching the toner to a surface of a photoreceptor on which an electrostatic latent image is formed to form a visualized image; and
transferring the visualized image to a transfer medium.

14. An image forming apparatus comprising:
an electrophotographic photoreceptor;
an image forming unit that forms an electrostatic latent image on a surface of the electrophotographic photoreceptor;
a unit to receive toner according to claim 10;
a toner supplying unit that supplies the toner onto the surface of the electrophotographic photoreceptor in order to form a toner image by developing the electrostatic latent image on the surface of the electrophotographic photoreceptor; and
a toner transferring unit that transfers the toner image to a transfer medium from the surface of the electrophotographic photoreceptor.
